(19) United States
(12) Patent Application Publication
(10) Pub. No.: US 2004/0076498 A1
(43) Pub. Date: Apr. 22, 2004

(54) Device for towing a motorcycle using a tow truck and method therefor

(76) Inventors: Patrick Kim Thompson, Scottsdale, AZ (US); Ken Wade, Scottsdale, AZ (US)

Correspondence Address: WEISS & MOY PC, 4204 NORTH BROWN AVENUE, SCOTTSDALE, AZ, 85251, US

(21) Appl. No.: 10/641,404

(22) Filed: Aug. 15, 2003

Related U.S. Application Data
(60) Provisional application No. 60/404,503, filed on Aug. 15, 2002.

(51) Int. Cl. B60P 9/00

(52) U.S. Cl. 414/462

(57) ABSTRACT

A device for securing a motorcycle that can be mounted onto a wheel lift bar of any commercial tow truck, including a flat bed tow truck and a wrecker tow truck, is used for towing a motorcycle. The motorcycle towing device comprises a front wheel assembly, a rear assembly, a ramp, and several ratchet straps. The motorcycle towing device is easy to assemble and can be easily stored in a typical storage compartment of the tow truck when not being used. The motorcycle can be pushed up a ramp into a channel where it is secured using ratchet straps. After lifting the wheel lift bar of the tow truck, the motorcycle is ready for towing. Since the motorcycle to be towed occupies only the wheel lift bar of a flat bed tow truck, a second vehicle can be towed at the same time on the flat bed platform.

### RELATED APPLICATIONS

This patent application is claiming the benefit of the U.S. Provisional Application having an application number of 60/404,503, filed Aug. 15, 2002, in the name of Pat Tompson and Ken Wade, and entitled “DEVICE FOR TOWING A MOTORCYCLE USING A TOW TRUCK AND METHOD THEREFOR”.

### BACKGROUND OF THE INVENTION

1. Field of the Invention

This invention relates generally to towing devices and method therefor and, more specifically, to a device for securing a motorcycle to a wheel lift bar of a tow truck and a method for towing a motorcycle.

2. Description of the Prior Art

In general, typical commercial tow trucks are divided mainly into two groups, flat bed tow trucks and wrecker tow trucks. The flat bed tow trucks occupy about 65% of the market, while the wrecker tow trucks occupy about 35% of the market. Conventional wheel lift bars and other devices found on typical commercial tow trucks are usually not adapted for towing two wheeled motor vehicles such as motorcycles.

Presently, a motorcycle can only be mounted on a flat bed tow truck using a motorcycle towing device, as shown in FIGS. 1 to 3. The motorcycle towing device, equipped with wheels and connected with a towing wrench of the flat bed tow truck, holds the motorcycle in an upright position. After the flat bed of the tow truck has been extended and touches the ground in a 30° angle, the motorcycle towing device can be lowered to the ground and can now receive the motorcycle to be towed. This start position is shown in FIG. 1. The motorcycle towing device is then pulled up onto the flat bed of the tow truck by the towing wrench until the motorcycle reaches the middle of the flat bed, as shown in FIG. 2. The flat bed of the tow truck is then moved back to its original position. Straps with mechanical grips are usually used to secure the motorcycle. The motorcycle is now ready for the transport, as shown in FIG. 3.

While this is convenient and works well, a problem occurs in the case where only a wrecker tow truck is available. The wrecker tow truck which is a smaller size tow truck is generally only equipped with a high strap and a lower wheel lift bar. There is no method of towing a motorcycle with this type of tow truck that will not damage mechanical parts or the paint of the motorcycle.

Therefore a need exists to provide a device for towing a motorcycle that can be used with either a flat bed tow truck or a wrecker tow truck. The device for towing a motorcycle must be relatively easy to assemble, easy to store in a typical storage box of a tow truck when not being used, reliable and inexpensive. A need further exists to provide a method for towing a motorcycle using either a flat bed tow truck or a wrecker tow truck. The method for towing a motorcycle must provide a stable transportation of the motorcycle preventing any damage.

### SUMMARY OF THE INVENTION

An object of the present invention is to provide a device for towing a motorcycle that can be used with either a flat bed tow truck or a wrecker tow truck.

It is still another object of the present invention to provide a device for securing a motorcycle to a wheel lift bar of a commercial tow truck.

It is a further object of the present invention to provide a device for securing a motorcycle to a wheel lift bar of a flat bed tow truck allowing the towing of a second vehicle on the flat bed of the tow truck at the same time.

It is a still further object of the present invention to provide a device for securing a motorcycle to a wheel lift bar of a commercial tow truck that can be easily stored in a typical storage compartment of the tow truck when not being used.

It is a still further object of the present invention to provide a device for securing a motorcycle to a wheel lift bar of a commercial tow truck that is relatively easy to assemble, inexpensive, and reliable.

It is a still further object of the present invention to provide a method for towing a motorcycle using either a flat bed tow truck or a wrecker tow truck.

It is a still further object of the present invention to provide a method for towing a motorcycle that allows a stable transportation of the motorcycle and therefore, prevents any damage to the motorcycle.

### BRIEF DESCRIPTION OF THE PREFERRED EMBODIMENTS

In accordance with one embodiment of the present invention a device for securing a motorcycle that can be mounted onto a wheel lift bar of any commercial tow truck, including a flat bed tow truck and a wrecker tow truck, is used for towing a motorcycle. The motorcycle towing device comprises a front wheel assembly, a rear assembly, a ramp, and several ratchet straps. The motorcycle towing device is easy to assemble and can be easily stored in a typical storage compartment of the tow truck when not being used. The motorcycle can be pushed up a ramp into a channel where it is secured using ratchet straps. After lifting the wheel lift bar of the tow truck, the motorcycle is ready for towing. Since the motorcycle to be towed occupies only the wheel lift bar of a flat bed tow truck, a second vehicle can be towed at the same time on the flat bed platform.

The foregoing and other objects, features, and advantages of the invention will be apparent from the following, more particular, description of the preferred embodiments of the invention, as illustrated in the accompanying drawing.

### BRIEF DESCRIPTION OF THE DRAWINGS

The novel features believed characteristic of the invention are set forth in the appended claims. The invention itself, as well as a preferred mode of use, and advantages thereof, will best be understood by reference to the following detailed description of illustrated embodiments when read in conjunction with the accompanying drawings, wherein like reference numerals and symbols represent like elements.

FIG. 1 is a perspective view of a prior art flat bed tow truck towing a motorcycle at start position.

FIG. 2 is a perspective view of a prior art flat bed tow truck towing a motorcycle at wrenched position.

FIG. 3 is a perspective view of a prior art flat bed tow truck towing a motorcycle at towing position.

FIG. 4 is an exploded perspective view of a motorcycle towing device according to the present invention.

FIG. 5 is an exploded perspective view of the motorcycle towing device according to the present invention partially mounted onto a wheel lift bar.

FIG. 6 is an exploded perspective view of the motorcycle towing device according to the present invention fully mounted onto a wheel lift bar.

FIG. 7 is a close up perspective view of the motorcycle towing device according to the present invention mounted onto the wheel lift bar of a tow truck at start position.

FIG. 8 is a perspective view of the motorcycle towing device according to the present invention mounted onto the wheel lift bar of a flat bed tow truck at start position.

FIG. 9 is a side view of the motorcycle towing device of FIG. 8.

FIG. 10 is a perspective view of the motorcycle towing device according to the present invention mounted onto the wheel lift bar of a flat bed tow truck at towing position.

FIG. 11 is a side view of the motorcycle towing device of FIG. 10.

FIG. 12 is a perspective view of a flat bed tow truck towing a four-wheeled motor vehicle and a motorcycle at the same time according to the present invention.

FIG. 13 is a perspective view of a flat bed tow truck towing two motorcycles at the same time according to the present invention.

FIG. 14 is a side view of the flat bed tow truck of FIG. 13.

FIG. 15 is a perspective view of the motorcycle towing device according to the present invention mounted onto the wheel lift bar of a wrecker tow truck at start position.

FIG. 16 is a side view of the motorcycle towing device of FIG. 15.

FIG. 17 is a perspective view of the motorcycle towing device according to the present invention mounted onto the wheel lift bar of a wrecker tow truck at towing position.

FIG. 18 is a side view of the motorcycle towing device of FIG. 17.

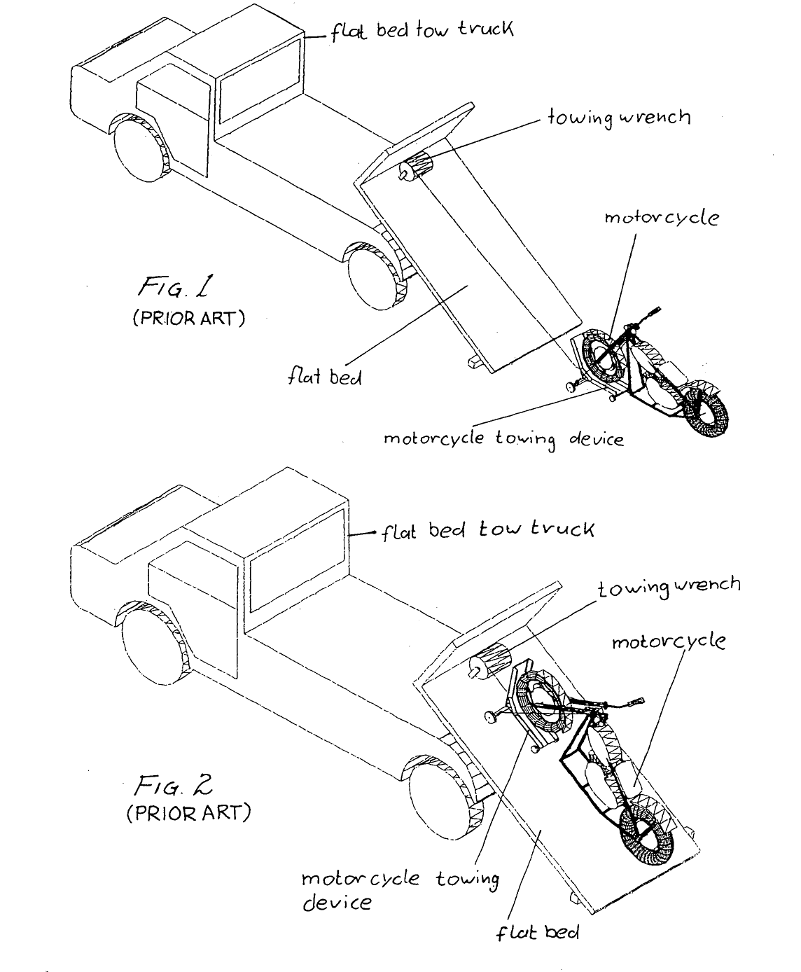

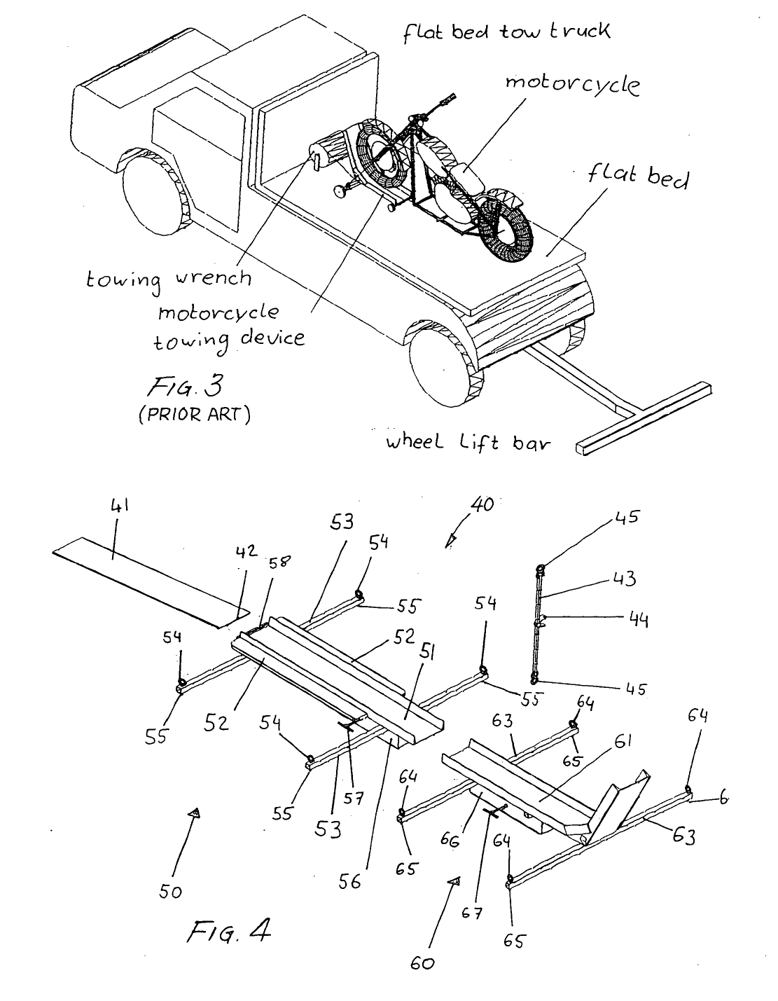

### DETAILED DESCRIPTION OF THE PREFERRED EMBODIMENTS

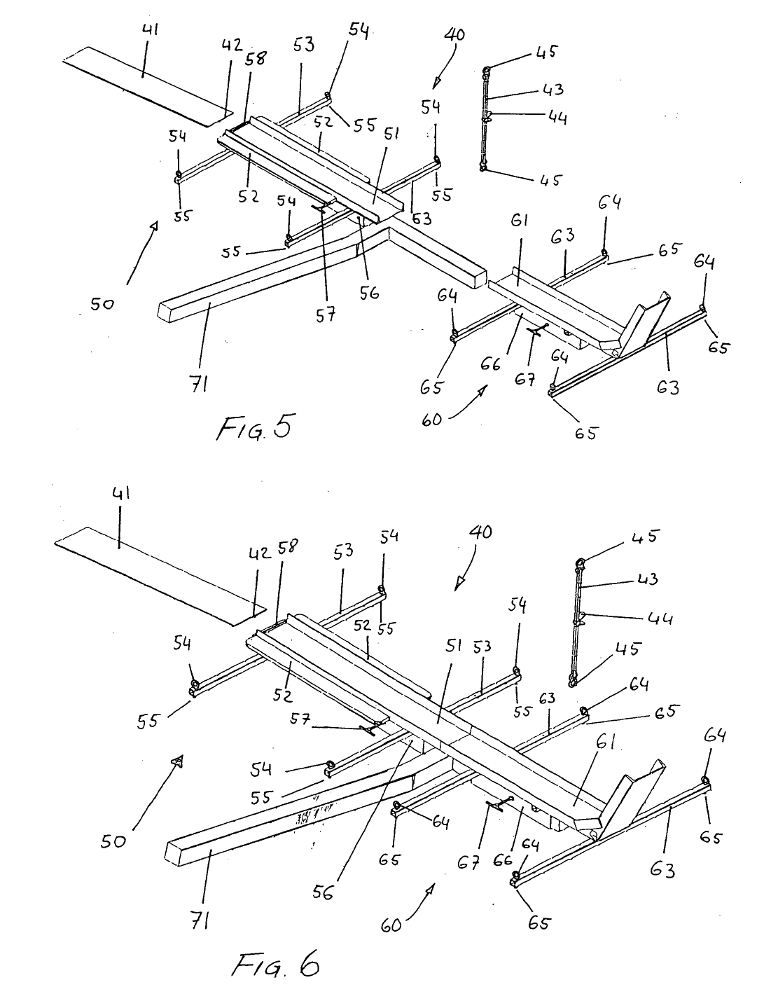

Referring to FIGS. 4, 5 and 6, an exploded perspective view of a motorcycle towing device 40 according to the present invention is shown. The motorcycle towing device 40 generally comprises, in combination: a left assembly 50, a right assembly 60, a ramp 41, and a plurality of ratchet straps 43. The left assembly 50 further comprises a channel 51 having a running board 52 mounted onto each side. Two support bars 53 are mounted perpendicular to the channel 51 and close to each end of the channel 51. Each support bar 53 has an aperture located at each distal end for receiving an eyebolt 54. The eyebolts 54 are fastened with nuts 55. The channel 51 and the at least two support bars 53 are mounted on a wheel lift cover sleeve 56. The wheel lift cover sleeve 56 is not limited to any size or shape and can be manufactured to fit over any wheel lift bar 71 of a tow truck 70, as shown in FIG. 5. The wheel lift cover sleeve 56 is fastened to the wheel lift bar 71 by a threaded T-bolt 57 which is tapped perpendicular to the wheel lift cover sleeve 56. The channel 51 also includes a relatively small groove 58 at the end facing towards the outside of the wheel lift bar 71. The ramp 41 interlocks with a lip 42 into the groove 58. With the ramp 41 connected to the channel 51 a motorcycle can be pushed up the ramp 41 and into the channel 51 at start position.

Still referring to FIGS. 4, 5 and 6, the right assembly 60 further comprises a channel 61 having one distal end angled upwards. In general, the distal end is bent at an angled of approximately 65°. The angled channel 61 prevents the motorcycle from being pushed accidentally over the edge. Two support bars 63 are mounted perpendicular to the channel 61. The first support bar 63 is mounted close to one end of the channel 61. The second support bar 63 is mounted just before the other end of the channel 61 is angled upwards. Each support bar 63 has an aperture located at each distal end for receiving an eyebolt 64. The eyebolts 64 are fastened with nuts 65. The channel 61 and the at least two support bars 63 are mounted on a wheel lift cover sleeve 66. The wheel lift cover sleeve 66 is not limited to any size or shape and can be manufactured to fit over any wheel lift bar 71 of a tow truck 70, as shown in FIG. 5. The wheel lift cover sleeve 66 is fastened to the wheel lift bar 71 by a threaded T-bolt 67 which is tapped perpendicular to the wheel lift cover sleeve 66. The left assembly, the right assembly, and the ramp are preferably manufactured out of steel.

Still referring to FIGS. 4, 5 and 6, the ratchet straps 43 further comprise a ratchet 44, and two hooks 45. The hooks 45 are fastened to each end of the strap 43. The strap 43 is manufactured out of a strap material.

FIG. 5 shows the left assembly 50 mounted onto the wheel lift bar 71 of a tow truck.

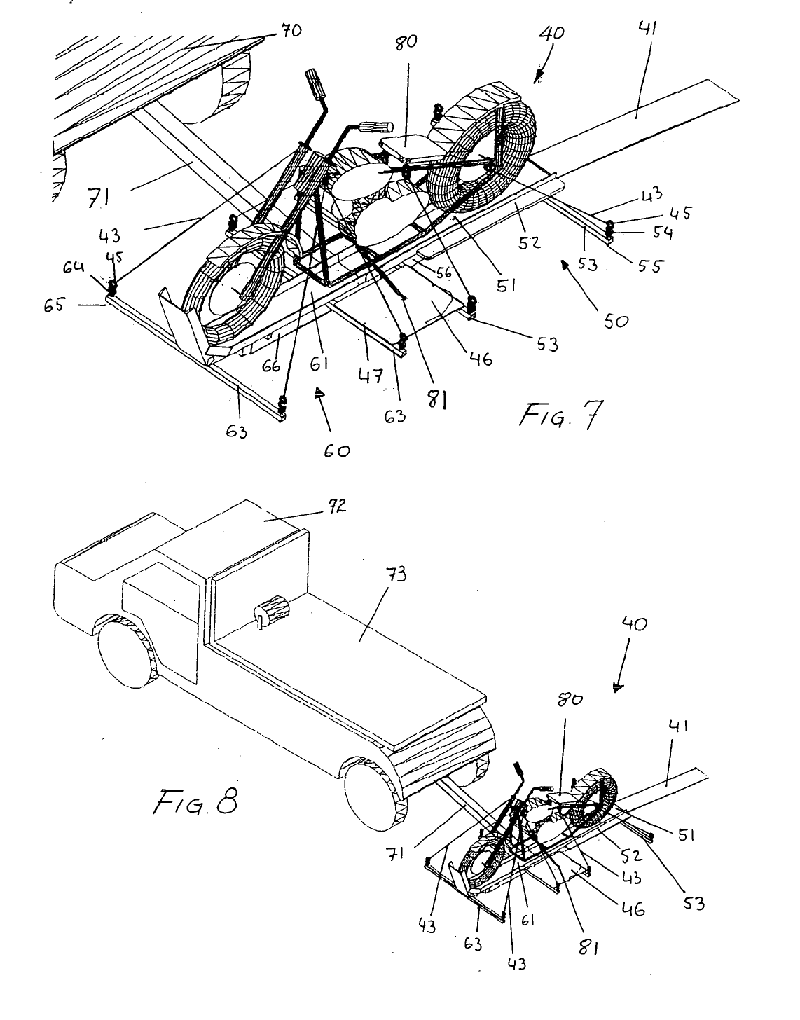

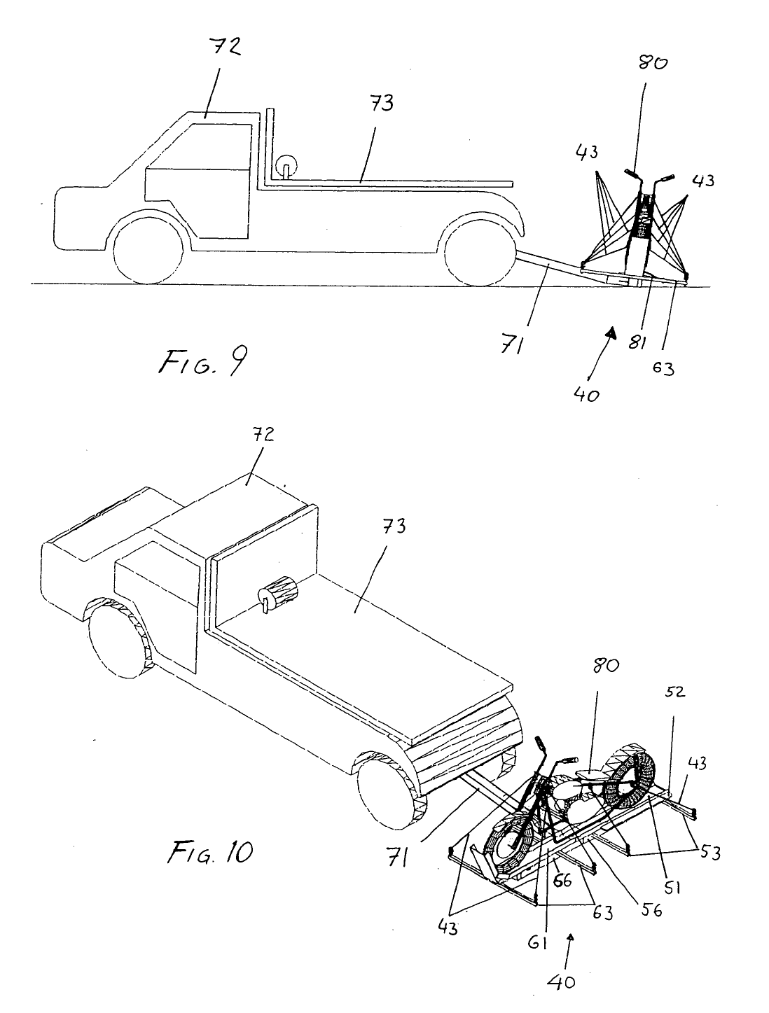

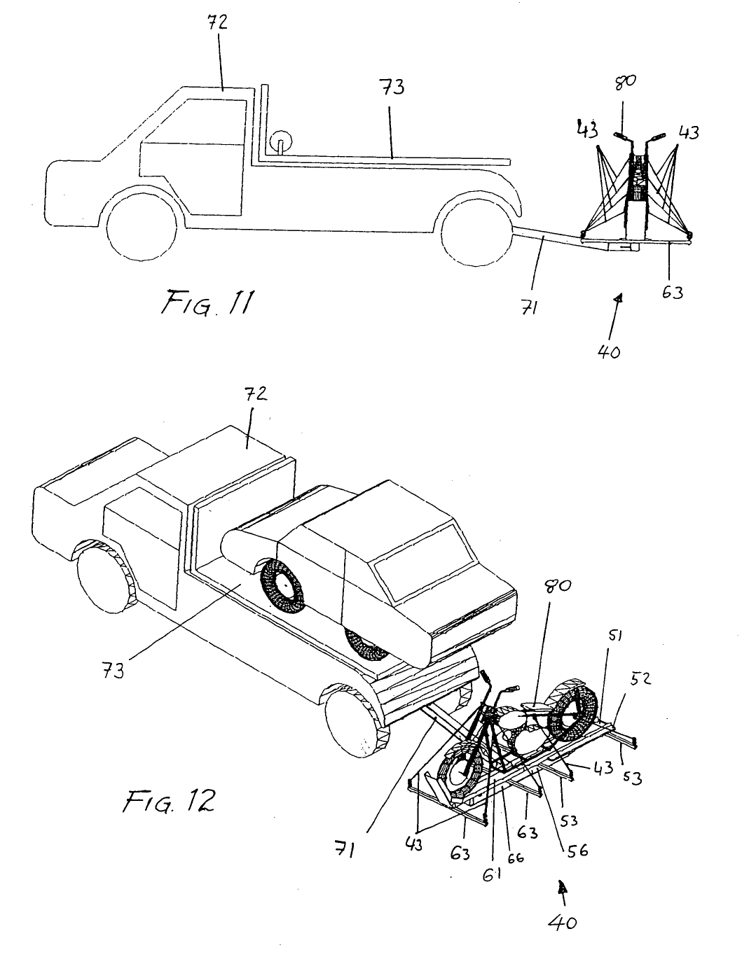

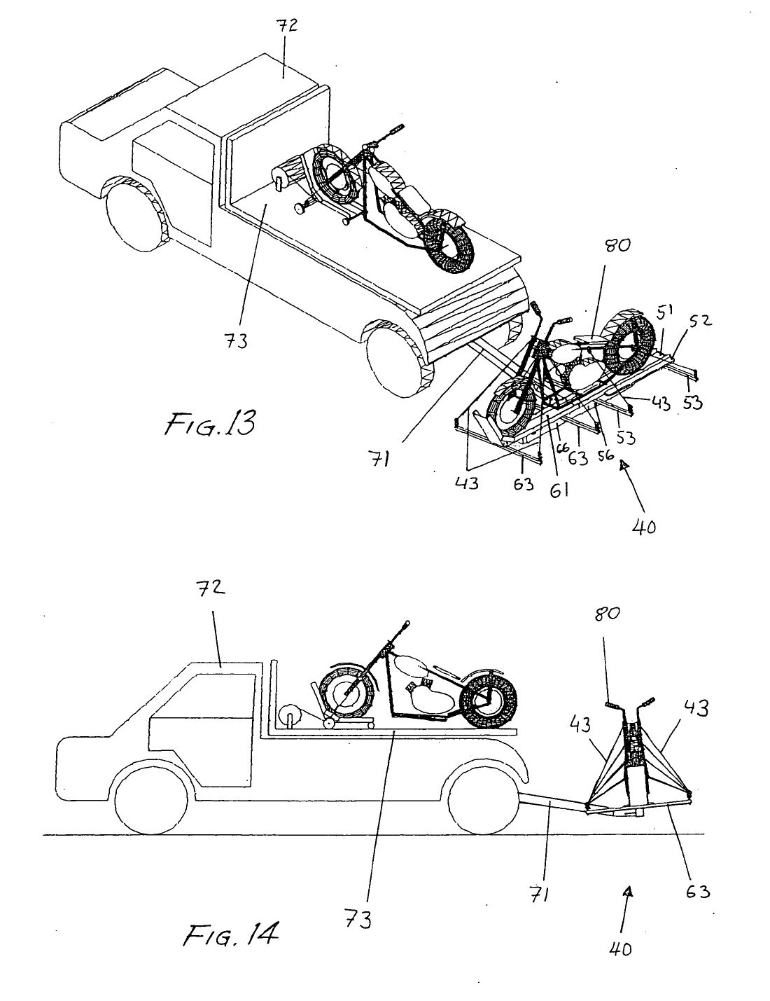

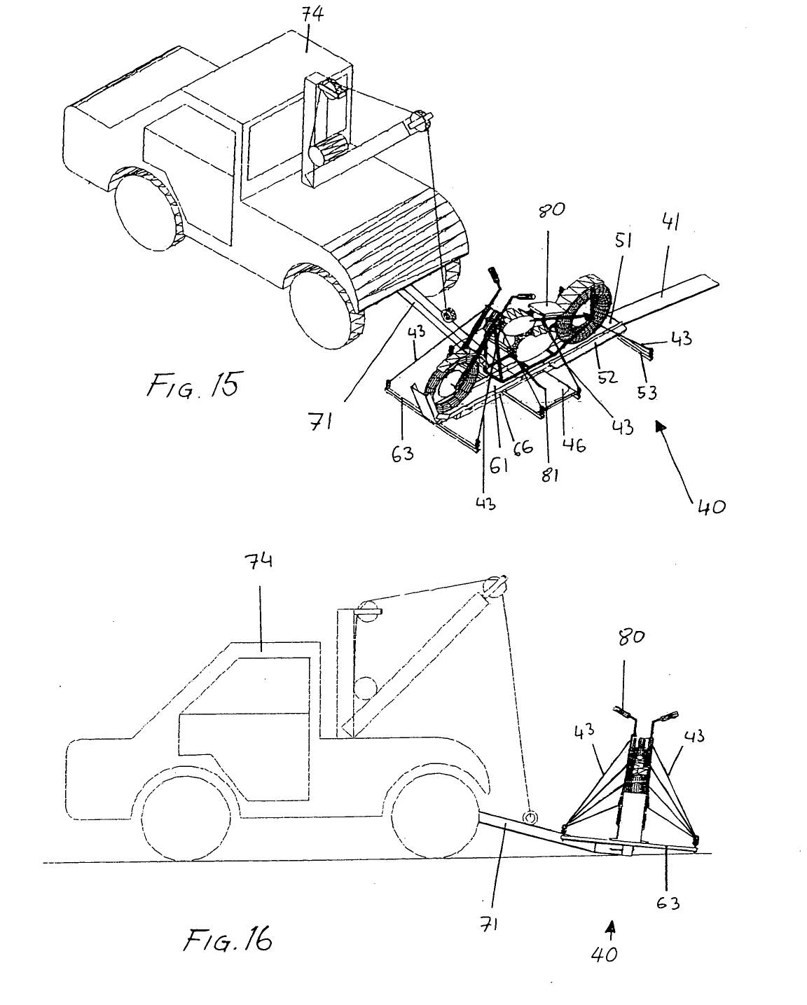

FIG. 6 shows both the left assembly 50 and the right assembly 60 mounted onto the wheel lift bar 71 of a tow truck.

Now referring to FIG. 7, a close up perspective view of the motorcycle towing device 40 according to the present invention mounted onto the wheel lift bar 71 of a tow truck 70 at start position is shown. After mounting the right assembly 60 and the left assembly 50 onto the wheel lift bar 71 and connecting the ramp 41 to channel 51, a plate 46 is attached to the two inner support bars 53 and 63 facing away from the tow truck 70. The plate 46 is attached using a minimum of one location pin 47 that is inserted through apertures in the plate 46 and in the support bars 53 and 63. Cotter pins 48 hold the location pins 47 in place. The motorcycle towing device 40 is now assembled and in start position. The motorcycle 80 can now be pushed up the ramp 41 and into the channel 51 and 61. The kickstand 81 of the motorcycle 80 can be put down on the plate 46 for stabilization. Now the motorcycle can be secured using the ratchet straps 43. One hook 45 of the ratchet straps 43 can be inserted into the apertures of the eyebolts 54 at the support bars 53. The other hook 45 of the ratchet straps 43 can be fastened at the motorcycle 80. Then the straps 43 are pulled tight using the ratchet 45 to hold the motorcycle 80 securely in place for towing.

FIG. 8 shows a perspective view of the motorcycle towing device 40 according to the present invention mounted onto the wheel lift bar 71 of a flat bed tow truck 72 at start position. After mounting the motorcycle towing device 40 onto the wheel lift bar 71 of a flat bed tow truck 72 and attaching the ramp 41 as well as the plate 46, the motorcycle 80 has been pushed up the ramp 41 and into the channel 51 and 61. There it was secured using the ratchet straps 43. The same situation is illustrated in FIG. 9, which is a side view of FIG. 8.

Now referring to FIG. 10, a perspective view of the motorcycle towing device 40 according to the present invention mounted onto the wheel lift bar 71 of a flat bed tow truck 72 at towing position is shown. Once the motorcycle 80 is ready for towing, the kickstand 81 is moved up. The ramp 41 and the plate 46 including the location pins 47 and cotter pins 48 are removed. The flat bed tow truck 72 then lifts the wheel lift bar 71 up and can proceed towing the motorcycle 80. The same situation is illustrated in FIG. 11, which is a side view of FIG. 10. As shown in FIGS. 10 and 11, while the motorcycle 80 is ready for towing, the flat bed platform 73 of the flat bed tow truck 72 is still empty and unused. Therefore, it is possible when using the motorcycle towing device 40 mounted onto the wheel lift bar 71 of a flat bed tow truck 72 for towing a motorcycle 80 according to the present invention, to use the flat bed platform 73 of the flat bed tow truck 72 for towing an additional car, as shown in FIG. 12, or for towing an additional motorcycle, as shown in FIGS. 13 and 14. This allows the tow truck company to operate more economically.

The use of the motorcycle towing device 40 according to the present invention for towing a motorcycle 80 is not limited to flat bed tow trucks 72 but can also be used with wrecker tow trucks 74, as shown in FIGS. 15, 16, 17, and 18.

Now referring to FIG. 15, a perspective view of the motorcycle towing device 40 according to the present invention mounted onto the wheel lift bar 71 of a wrecker tow truck 74 at start position is shown. After mounting the motorcycle towing device 40 onto the wheel lift bar 71 of a wrecker tow truck 74 and attaching the ramp 41 as well as the plate 46, the motorcycle 80 has been pushed up the ramp 41 and into the channel 51 and 61. There it was secured using the ratchet straps 43. The same situation is illustrated in FIG. 16, which is a side view of FIG. 15.

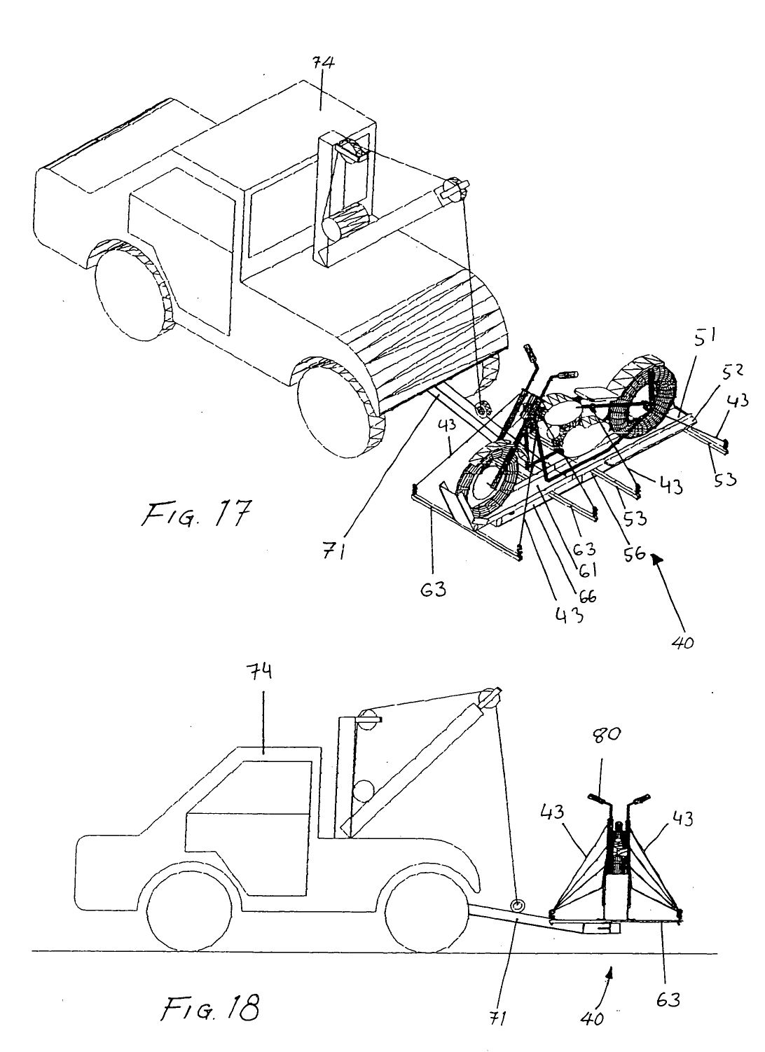

Now referring to FIG. 17, a perspective view of the motorcycle towing device 40 according to the present invention mounted onto the wheel lift bar 71 of a wrecker tow truck 74 at towing position is shown. Once the motorcycle 80 is ready for towing, the kickstand 81 is moved up. The ramp 41 and the plate 46 including the location pins 47 and cotter pins 48 are removed. The wrecker tow truck 74 then lifts the wheel lift bar 71 up and can proceed towing the motorcycle 80. The same situation is illustrated in FIG. 18, which is a side view of FIG. 17.

By providing the motorcycle towing device 40, problems associated with prior art motorcycle towing devices are solved. The motorcycle towing device 40 according to the present invention can be used for securing a motorcycle 80 to a wheel lift bar 71 of any commercial tow truck 70, including a flat bed tow truck 72 and a wrecker tow truck 74. The motorcycle towing device 40 according to the present invention can be manufactured to fit a wheel lift bar 71 of any shape and size.

Since only the wheel lift bar 71 of a flat bed tow truck 72 is occupied for towing a motorcycle 80 when using the motorcycle towing device 40, an additional four wheeled motor vehicle or an additional motorcycle can be towed at the same time on the flat bed platform 73.

The motorcycle towing device 40 consists of several relatively small parts. Therefore, it is relatively easy to assemble and can be easily stored in a typical storage compartment of the tow truck 70 when not being used.

While the invention has been particularly shown and described with reference to preferred embodiments thereof, it will be understood by those skilled in the art that the foregoing and other changes in form and details may be made therein without departing from the spirit and scope of the invention.

What is claimed is:

1. A device for towing a two wheel vehicle on a wheel lift bar comprising:
a wheel lift cover sleeve for coupling the device to the wheel lift bar;
a first wheel holder assembly coupled to the wheel lift cover sleeve for holding the front tire of the two wheel vehicle;
a second wheel holder assembly coupled to the wheel lift cover sleeve for holding the rear tire of the two wheel vehicle;
a ramp member removably coupled to the second wheel holder assembly for loading the two wheel vehicle on the device; and
a plurality of holding device for coupling the two wheel vehicle to the device.

2. A device for towing a two wheel vehicle on a wheel lift bar in accordance with claim 1 further comprising a plate member coupled to the first wheel holder assembly and the second wheel holder assembly for supporting a kick stand of the two wheel vehicle when the two wheel vehicle is positioned on the device.

3. A device for towing a two wheel vehicle on a wheel lift bar in accordance with claim 1 further comprising a locking device for locking the wheel lift cover sleeve to the wheel lift bar.

4. A device for towing a two wheel vehicle on a wheel lift bar in accordance with claim 1 wherein the wheel lift cover sleeve comprises:
a first sleeve member which can be removably coupled to a first end of the wheel lift bar; and
a second sleeve member which can be removably coupled to a second end of the wheel lift bar.

5. A device for towing a two wheel vehicle on a wheel lift bar in accordance with claim 4 wherein the first wheel holder assembly comprises:
a front wheel channeling coupled to the first sleeve member for supporting the front wheel of the two wheel vehicle wherein a distal end of the front wheel channeling is angled upward to prevent the front wheel of the two wheel vehicle from rolling over the edge of the front wheel channeling; and
front support arms coupled to the front wheel assembly for coupling the holding devices to the device.

6. A device for towing a two wheel vehicle on a wheel lift bar in accordance with claim 5 further comprising eye bolts coupled to each end of the front support arms for coupling the holding devices to the front support arms.

7. A device for towing a two wheel vehicle on a wheel lift bar in accordance with claim 4 wherein the second wheel holder assembly comprises:
a rear wheel channeling coupled to the second sleeve member for supporting the rear wheel of the two wheel vehicle; and
rear support arms coupled to the rear wheel assembly for coupling the holding devices to the device.

8. A device for towing a two wheel vehicle on a wheel lift bar in accordance with claim 7 further comprising eye bolts coupled to each end of the rear support arms for coupling the holding devices to the rear support arms.

9. A device for towing a two wheel vehicle on a wheel lift bar in accordance with claim 1 wherein the holding devices are ratchet straps.

10. A device for towing a two wheel vehicle on a wheel lift bar in accordance with claim 9 wherein each ratchet strap comprises:
a strap member;
attachment devices coupled to each end of the strap member for attaching each end of the strap member to an object; and
a ratchet device coupled to the strap member for tightening the strap member.

11. A device for towing a two wheel vehicle on a wheel lift bar comprising:
a wheel lift cover sleeve for coupling the device to the wheel lift bar wherein the wheel lift cover sleeve comprises:
a first sleeve member which can be removably coupled to a first end of the wheel lift bar; and
a second sleeve member which can be removably coupled to a second end of the wheel lift bar;
a first wheel holder assembly wherein the first wheel holder assembly comprises:
a front wheel channeling coupled to the first sleeve member for supporting the front wheel of the two wheel vehicle wherein a distal end of the front wheel channeling is angled upward to prevent the front wheel of the two wheel vehicle from rolling over the edge of the front wheel channeling; and
front support arms coupled to the front wheel assembly for coupling the holding devices to the device;
a second wheel holder assembly wherein the second wheel holder assembly comprises:
a rear wheel channeling coupled to the second sleeve member for supporting the rear wheel of the two wheel vehicle; and
rear support arms coupled to the rear wheel assembly for coupling the holding devices to the device;
a ramp member removably coupled to the second wheel holder assembly for loading the two wheel vehicle on the device; and
a plurality of holding device for coupling the two wheel vehicle to the device.

12. A device for towing a two wheel vehicle on a wheel lift bar in accordance with claim 11 further comprising a plate member coupled to the first wheel holder assembly and the second wheel holder assembly for supporting a kick stand of the two wheel vehicle when the two wheel vehicle is positioned on the device.

13. A device for towing a two wheel vehicle on a wheel lift bar in accordance with claim 11 further comprising a locking device for locking the wheel lift cover sleeve to the wheel lift bar.

14. A device for towing a two wheel vehicle on a wheel lift bar in accordance with claim 5 further comprising eye bolts coupled to each end of the front support arms and the rear support arms for coupling the holding devices to the front support arms and the rear support arms.

15. A device for towing a two wheel vehicle on a wheel lift bar in accordance with claim 11 wherein the holding devices are ratchet straps.

16. A device for towing a two wheel vehicle on a wheel lift bar in accordance with claim 15 wherein each ratchet strap comprises:
a strap member;
attachment devices coupled to each end of the strap member for attaching each end of the strap member to an object; and
a ratchet device coupled to the strap member for tightening the strap member.
